(19) United States
(12) Patent Application Publication
(10) Pub. No.: US 2006/0098262 A1
(43) Pub. Date: May 11, 2006

(54) Micromirror array and method of manufacturing the same

(75) Inventors: Hae-sung Kim, Hwaseong-si (KR); Jin-seung Sohn, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRO-MECHANICS CO., LTD.

(21) Appl. No.: 11/270,555

(22) Filed: Nov. 10, 2005

(30) Foreign Application Priority Data
Nov. 11, 2004 (KR) 10-2004-0092106

(51) Int. Cl. G02B 26/08

(52) U.S. Cl. 359/224

(57) ABSTRACT

A micromirror array and a method of manufacturing the same are provided. The method of manufacturing the micromirror array used in controlling a light path of an optical element includes: forming at least one alignment pattern in which a micromirror is to be seated on a substrate; and seating the micromirror having at least one reflective surface in the alignment pattern.

This application claimse priority from Korean Patent Application No. 10-2004-0092106, filed on Nov. 11, 2004, in the Korean Intellectual Property Office, the disclosure of which is incorporated herein in its entirety by reference.

### BACKGROUND OF THE INVENTION

1. Field of the Invention

The present invention relates to a micromirror array and, more particularly, to a micromirror array in which a micromirror widely used as an ultra-small optical component can be manufactured with high precision, and a method of manufacturing the same.

2. Description of the Related Art

Micromirrors are optical elements that have been widely used in an optical pickup device or an optical communication system and the like. Optical information storage devices having an optical pickup can record and reproduce information on and from an optical disc.

The optical information storage devices have been developed to reduce a wavelength of a light source and to increase a numerical aperture (NA) of an objective lens so that a high recording density can be achieved using an optical energy. For example, optical information storage devices for CDs employ a light source having a wavelength of 780 nm and an objective lens having the numerical aperture (NA) of 0.45, and optical information storage devices for DVDs employ a light source having a wavelength of 650 nm and an objective lens having the NA of 0.6.

As users want to employ an optical disc in a portable information device, ultra-small optical pickups have been briskly developed. Optical pickups have been attempted to be manufactured using semiconductor processes. In conventional optical pickup manufacturing processes, it takes a long time to adjust an optical axis between optical components when the optical components in units of several millimeters are assembled, and an automation rate is reduced. However, optical pickups can be manufactured at a wafer level using semiconductor processes so that mass-production is possible, small-sized optical pickups can be made and assembling and adjustment can be easily performed.

FIGS. 1A through 1E illustrate a conventional method of manufacturing a micromirror using semiconductor processes.

Referring to FIG. 1A, a silicon ingot is cut to have a 9.74-degree off-axis angle with respect to a direction [011] of a plane (100) so as to form a silicon wafer 10 to a thickness of 500 μm. Referring to FIG. 1B, etching mask layers 11 and 12 are formed as SiO₂ or SiNₓ at both sides of the silicon wafer 10.

Referring to FIG. 1C, an etching window 13 is formed at a portion of the etching mask layer 11 using a photolithography process.

Referring to FIG. 1D, the silicon wafer 10 in which the etching window 13 is formed is soaked in a silicon anisotropic etching solution such as KOH or TMAH maintained at an appropriate temperature, thereby performing wet etching. When wet etching is performed for a predetermined amount of time, as shown in FIG. 1D, a first surface 15a having an inclined angle of about 45 degrees with respect to a lower surface of the silicon wafer 10 and a second surface 15b having an inclined angle of about 64.48 degrees with respect to the lower surface of the silicon wafer 10. Reference numeral 14 denotes an etched region of the silicon wafer 10.

Referring to FIG. 1E, the etching mask layers 11 and 12 are removed and the silicon wafer 10 is cut so that the first surface 15a and the second surface 15b are used as a micromirror.

The micromirror can be manufactured at a wafer level, and when a light source having a long wavelength is used or an etching depth is small, surface precision can be achieved. However, in the conventional method of manufacturing a micromirror shown in FIGS. 1A through 1E, when an etching depth is hundreds of μms, surface shaping precision cannot be easily substituted with shaping precision required in conventional optical components for optical pickups.

Surface roughness of a micromirror that satisfies an optical criterion in an optical pickup system is obtained using Equation 1
Rt<λ/6 (1),
where Rt is ten-point average roughness and λ is a wavelength of light used in an optical pickup system. Thus, since a wavelength of light is about 405 nm in a Blu-ray optical pickup system, precision of a mirror surface requires surface roughness smaller than about 68 nm.

The micromirror manufactured using an etching process shown in FIGS. 1A through 1E is widely used in an optical pickup and in a variety of optical communication devices including an optical module. However, a wavelength of light can be used in an optical system that uses light having a wavelength in the range of 1.3 to 1.5 μm and cannot be easily used in a system that uses light having a wavelength less than 1.3 to 1.5 μm.

In the conventional method of manufacturing a large-sized micromirror having an array shape using an etching process, a large-sized Si wafer having high purity is used, experimental conditions should be strictly managed and a time required for etching a wafer is about 8 to 10 hours, which causes the cost of manufacturing the micromirror to increase.

### SUMMARY OF THE INVENTION

The present invention provides a micromirror array in which alignment pattern and alignment mark forming processes and a process of attaching a micrormirror are very simply performed to improve productivity greatly and a method of manufacturing the same.

According to an aspect of the present invention, there is provided a micromirror array used in controlling a light path of an optical element, the micromirror array including: a substrate; at least one alignment pattern formed at one surface of the substrate; and a micromirror seated in the alignment pattern and having at least one mirror surface.

The substrate may be one of an Si substrate and a glass substrate. The micromirror may be formed of at least one of Si, glass, and polymer.

One of metal and a dielectric material coated of one of a single layer and multiple layers may be used in the mirror surface so as to improve reflectivity.

The micromirror may include a first surface having a first inclined angle and a second surface having a second inclined angle.

According to another aspect of the present invention, there is provided a method of manufacturing a micromirror array used in controlling a light path of an optical element, the method including: forming at least one alignment pattern in which a micromirror is to be seated on a substrate; and seating the micromirror having at least one reflective surface in the alignment pattern.

The forming of at least one alignment pattern may include coating photoresist on the substrate to form an etching mask layer; placing a photomask having an opened portion corresponding to the alignment pattern above an upper portion of the etching mask layer and performing a photolithography process and developing the etching mask layer and opening the etching mask layer corresponding to the alignment pattern to form an etching window; and dry etching the substrate through the etching window to form an alignment pattern in the substrate.

The forming of at least one alignment pattern may further include forming an alignment mark to be aligned and bonded to an optical element such as an SiOB on the substrate.

The forming of the alignment mark may include: forming a photoresist layer by coating a photoresist on the substrate; placing a photomask layer having an opened portion corresponding to the alignment mark above the photoresist layer and performing a photolithography process from an upper portion of the photomask layer; exposing a portion of the substrate by removing the photoresist layer from the portion in which the alignment mark is to be formed; and coating an alignment mark material layer on the exposed portion of the substrate and the photoresist layer and removing the photoresist layer to form the alignment mark.

The seating of the micromirror in the alignment pattern may include: placing the micromirror in the alignment pattern; aligning the micromirror in one-side direction of the alignment pattern; and injecting a bonder into a contact portion of the micromirror and the alignment pattern.

The bonder may be at least one of a silver paste, UV polymer, a UV bonder, and a photoresist.

### BRIEF DESCRIPTION OF THE DRAWINGS

The above aspects and advantages of the present invention will become more apparent by describing in detail exemplary embodiments thereof with reference to the accompanying drawings, in which:

FIGS. 1A through 1E illustrate a conventional method of manufacturing a micromirror using semiconductor processes;

FIGS. 2A and 2B show a structure of a micromirror array according to an exemplary embodiment of the present invention;

FIGS. 3A through 3I illustrate a method of manufacturing a micromirror array according to another exemplary embodiment of the present invention;

FIGS. 4A through 4C illustrate a method of seating a micromirror on an alignment pattern of a substrate according to another exemplary embodiment of the present invention; and

FIGS. 5 and 6 show an optical pickup in which a micromirror array is bonded to an SiOB at a wafer level and formed.

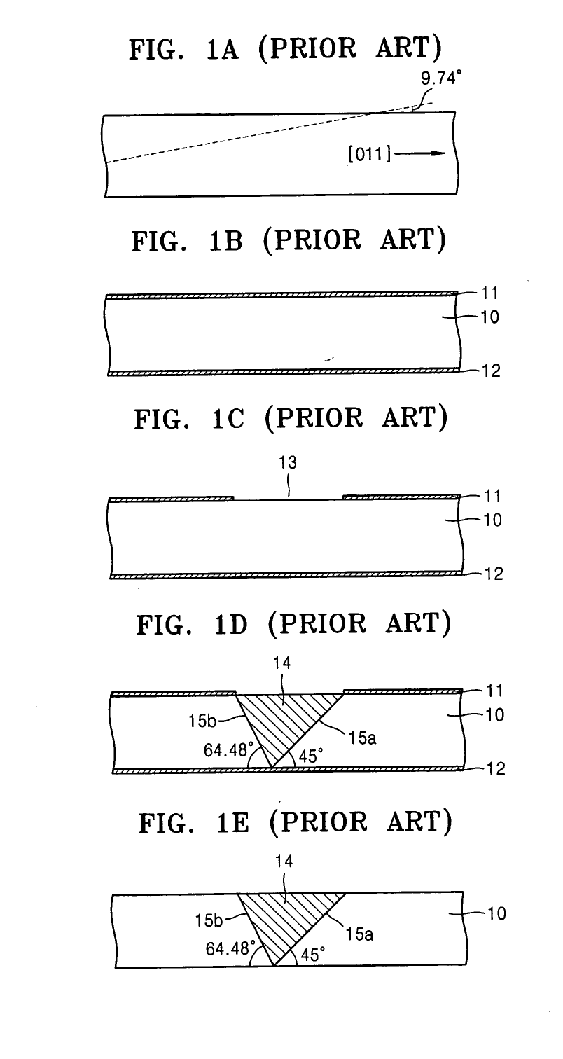

### DETAILED DESCRIPTION OF ILLUSTRATIVE, NON-LIMITING EMBODIMENTS OF THE INVENTION

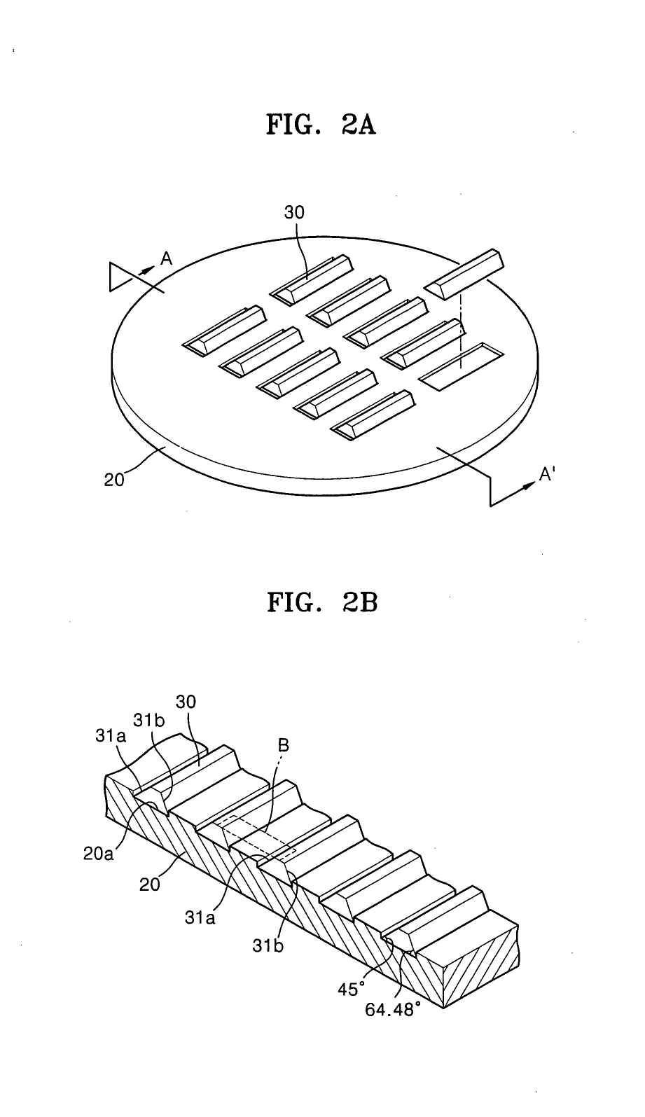

FIGS. 2A through 2B show a structure of a micromirror array according to an exemplary embodiment of the present invention.

Referring to FIG. 2A, a micromirror 30 is aligned in a predetermined shape on an alignment pattern of a substrate 20. Here, the micromirror 30 is not formed by processing the substrate 20 using processes such as etching but is formed by seating the separate micromirror 30 in the alignment pattern formed on the substrate 20.

FIG. 2B is a perspective view of the micromirror 30 taken along line A-A′ of FIG. 2A. Referring to FIG. 2B, alignment patterns 20a in which the micromirror 30 is aligned and seated are formed on the substrate 20. The micromirror 30 includes a first surface 31a having a first inclined angle with respect to a surface of the substrate 20 and a second surface 31b having a second inclined angle with respect to the surface of the substrate 20. Here, the inclined angles of the first surface 31a and the second surface 31b may be adjusted depending on the purpose for which they are used. For example, when they are used in an optical pickup, the first surface 31a has an inclined angle of about 45 degrees, and the second surface 31b has an inclined angle of about 64.48 degrees. A region B of FIG. 2B is a region where the micromirror 30 is to be bonded to a silicon optical bench (SiOB) at a wafer level, which will be described later.

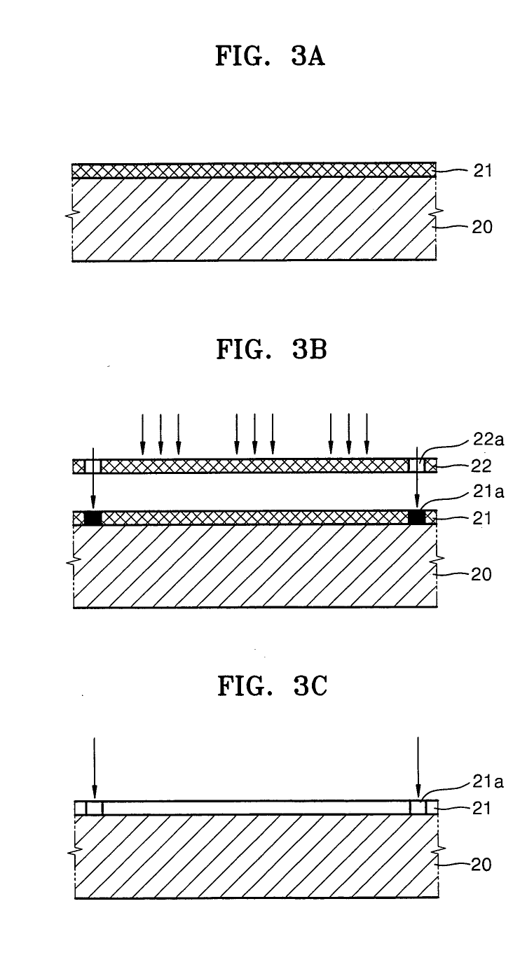

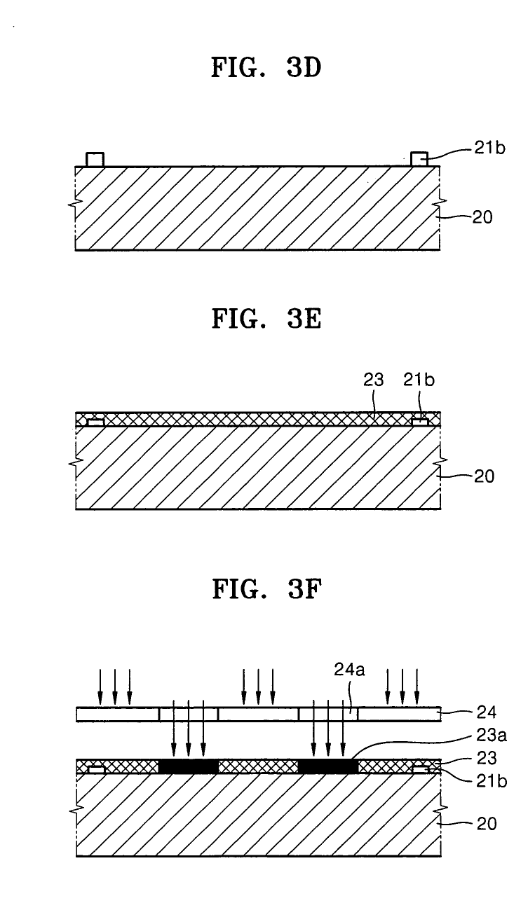

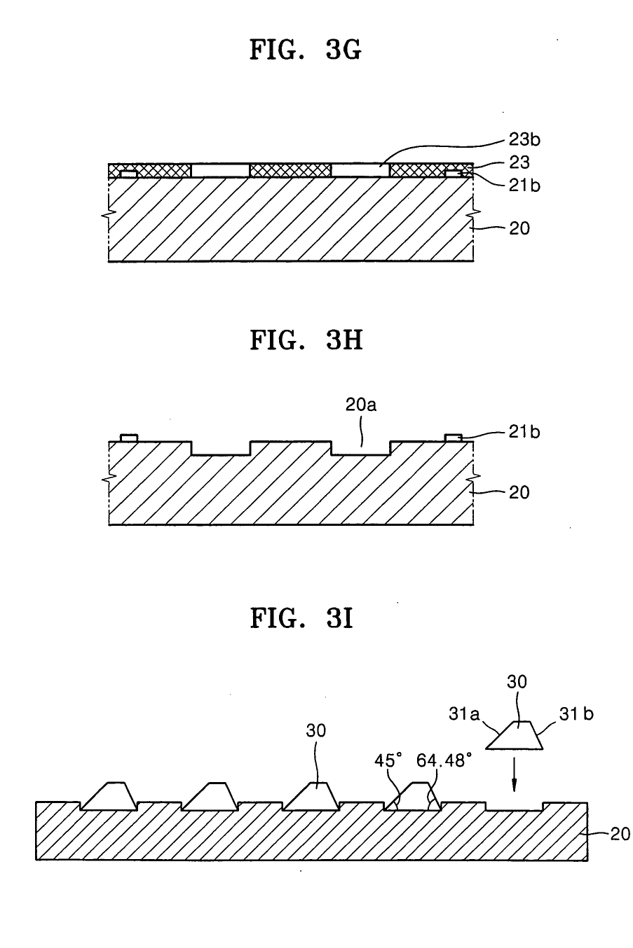

A method of manufacturing a micromirror according to an exemplary embodiment of the present invention will now be described with reference to FIGS. 3A through 3I. Here, the method of manufacturing a micromirror including a process of seating the micromirror 30 on the substrate 20 and forming an alignment mark for bonding the micromirror 30 to an optical element such as an SiOB will be described below.

Referring to FIG. 3A, a substrate 20 is prepared and a photoresist is coated on the substrate 20, thereby forming a photoresist layer 21. Any material of which alignment patterns, such as Si or glass, can be formed can be used for the substrate 20. Even in an Si wafer, an Si ingot can be used on a general (100) substrate as well as in a predetermined surface direction, like in the prior art described above.

Referring to FIG. 3B, a photomask 22 in which a location 22a where an alignment mark 21 is to be formed is placed on the substrate 20, and light is irradiated from an upper portion of the photomask 22, thereby performing a photolithography process.

Referring to FIG. 3C, the photomask 22 is removed and developed so that the photoresist layer 21 of a location 21a where an alignment mask 21b is to be formed is removed. Metal such as Au or Cr is deposited using sputtering or E-beam evaporation, thereby being filled in the photoresist layer 21 of the location 21a where the alignment mask 21b is to be formed.

Referring to FIG. 3D, the photoresist is removed using a lift-off process to separate the photoresist layer 21 from the substrate 20 so that the alignment mark 21b is formed at a predetermined location of the substrate 20.

As such, the alignment mark 21b which will be bonded to an SiOB in a subsequent process is formed. A process of forming the alignment patterns 20a on which the micromirror 30 is to be seated will now be described.

Referring to FIG. 3E, the photoresist is coated on the substrate 20 and the alignment mark 21b using spin coating, thereby forming an etching mask layer 23.

Referring to FIGS. 3F and 2B, a photomask 24 having an opened portion 24a corresponding to each alignment pattern 20a on which the micromirror 30 is to be seated is placed above the etching mask layer 23, thereby performing a photolithography process. A portion of the etching mask layer 23 corresponding to each alignment pattern 20a is exposed through the photomask 24a.

Referring to FIG. 3G, when a development process is performed, a portion of the etching mask layer 23 is removed and an etching window 23b is formed.

Referring to FIG. 3H, dry etching is performed on a portion of the substrate 20 opened through the etching window 23b. Thus, the alignment patterns 20a on which the micromirror 30 is to be seated are formed on the substrate 20. When the etching mask layer 23 is removed, the alignment pattern 20a and the alignment mark 21b are formed on the substrate 20. In this case, the depth of each alignment pattern 20a is determined in consideration of the size of the micromirror 30, and the micromirror 30 is seated on the alignment pattern 20a and is used to align and combine with the SiOB in a subsequent process. Thus, the size of the micromirror 30 is adjusted to several to several tens of micrometers.

Referring to FIG. 3I, the micromirror 30 is seated on the alignment pattern 20a formed on the substrate 20. The micromirror 30 has side surfaces, that is, a first surface 31a having the first inclined angle and the second surface 31b having the second inclined angle. The size of the bottom surface of the micromirror 30 is smaller than the size of the alignment pattern 20a. The micromirror 30 can be easily formed by controlling its shape and size using silicon, glass such as BK7 or Pyrex, or polymer, using machine processing to have a desired inclined angle. In order to improve reflectivity of a reflective surface, metal or a dielectric material coated of a single layer or multiple layers is used in the surface of the first surface 31a and the second surface 31b. When the micromirror 30 is used in an optical element such as an SiOB, the first surface 31a has an inclined angle of 45 degrees and the second surface 31b has an inclined angle of 64.48 degrees. As such, a micromirror array according to an embodiment of the present invention can be manufactured.

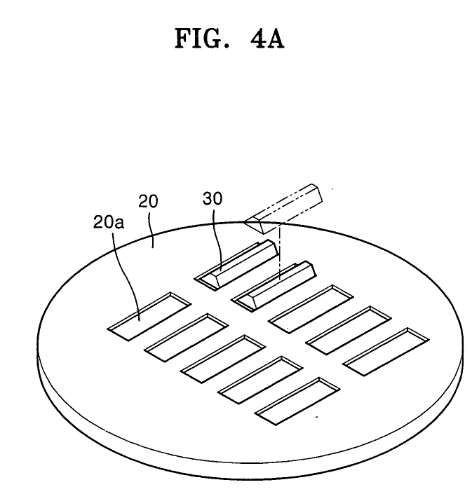

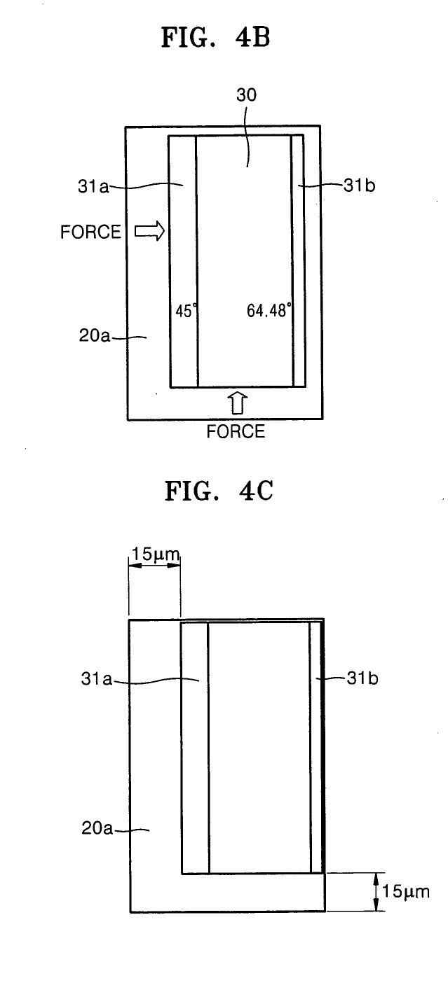

FIGS. 4A through 4C illustrate a method of seating the micromirror 30 on the alignment pattern 20a of the substrate 20 according to another exemplary embodiment of the present invention.

Referring to FIG. 4A, the micromirrors 30 are seated on the plurality of alignment patterns 20a formed in the substrate 20 to be aligned in the alignment patterns 20a. The width of the alignment pattern 20a may be larger than the micromirror 30. According to the present invention, the width and length of the alignment patterns 20a are formed to be about 15 micrometers larger than a lower surface of the micromirror 30.

Referring to FIG. 4B, the micromirror 30 is seated on the alignment pattern 20a in consideration of directions of the first surface 31a and the second surface 31b. The top side and right side of FIG. 4B are set as reference alignment surfaces so that force is applied from a left direction and a downward direction of the micromirror 30.

Referring to FIG. 4C, the micromirror 30 is accurately bonded to the top side and the right side which are alignment surfaces of the alignment pattern 20. Since a process of bonding an array of the micromirror 30 to a wafer in which SiOBs are formed in an array shape is performed in a subsequent process, the micromirror 30 should be fixed in the alignment pattern 20. To this end, silver paste, UV polymer, UV bonder, or photoresist can be used as a bonder. For example, a small amount of a bonder can be injected into one side or both sides of the micromirror 30 using optical fiber. Then, UV rays are irradiated onto the bonder or the bonder is heated in a hot plate or a conventional oven to remove a solvent component of the bonder. Thus, the micromirror 30 is bonded to the alignment pattern 20a. The micromirror 30 can be easily bonded to the alignment pattern 20a only using a small amount of a bonder.

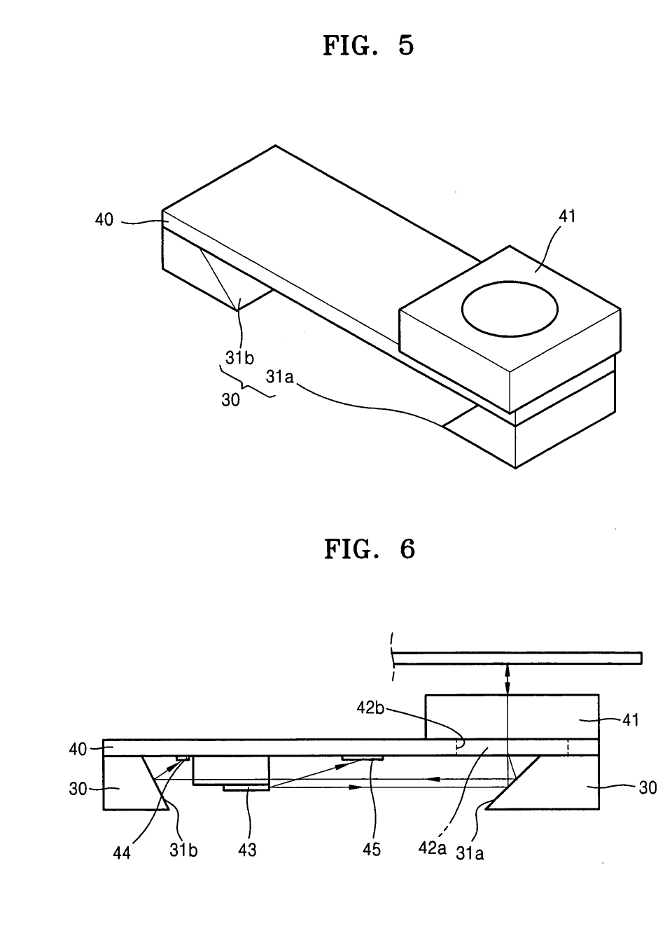

FIGS. 5 and 6 show a structure of an optical pickup in which a micromirror array is bonded to an SiOB at a wafer level and formed. The optical pickup is constructed in such a way that the micromirror array shown in FIG. 2A is aligned at a wafer level in which an array of SiOBs is formed, using an alignment mark and anodic bonded or eutectic bonded. The micromirror bonded to a unit SiOB optical element correspond to a region B of FIG. 2B.

Referring to FIGS. 5 and 6, the optical pickup includes an optical bench 40, a mount unit 43 formed on the optical bench 40 and having a light source, a lens unit 41, a micromirror 30, and a light path-separating unit 42a. A light-passing hole 42b through which light passes from the light source of the mount unit 43 is formed in the optical bench 40. A main photodetector 44 and a monitor photodetector 45 are formed in the optical bench 40.

The micromirror 30 includes a first surface 31a, which is disposed at one side of the optical bench 40 and on which light emitted from the light source of the mount unit 43 is reflected by the light-passing hole 42b and incident into an information storage medium, and a second surface 31b on which reflected light transmitted from the first surface 31a is incident into the main photodetector 44.

The main photodetector 44 receives light reflected from the information storage medium and detects an information reproduction signal such as an RF signal and an error signal such as a focus error signal, a tracking error signal, or a tilting error signal used in servo driving. The monitor photodetector 45 receives a portion of the light emitted from the light source of the mount unit 43 and generates a monitoring signal using the amount of light.

The light-path separating unit 42a separates a path of light emitted from the light source of the mount unit 43 and incident into the information storage medium and a path of light reflected from the information storage medium from each other. The light-path separating unit 42a can use a diffractive optical element such as a hologram optical element (HOE) or a diffractive optical element (DOE).

The operation of the optical pickup will now be described. Light emitted from the light source of the mount unit 43 is reflected from the first surface 31a of the micromirror 30 and is incident into an information storage medium such as a CD through the light-passing hole 42b. The light reflected from the information storage medium is incident into the first surface 31a of the micromirror 30 through the light-passing hole 42b. The light reflected from the first surface 31a is incident into the second mirror 31b and received by the main photodetector 44. Thus, the micromirror 30 should be precisely bonded to an SiOB so as to precisely control a light path. In the micromirror array according to an exemplary embodiment of the present invention, the alignment patterns 20a are formed in consideration of an alignment surface and can satisfy precision of an optical element such as an optical pickup.

According to the present invention, the following advantages can be obtained. First, conventionally, an etching time required for manufacturing a micromirror using wet etching is longer so that productivity is low. However, according to the present invention, a process of forming alignment patterns and alignment marks can be very simply performed and a process of attaching a separate micromirror can be very simply performed such that productivity is greatly improved. Second, when a conventional micromirror is manufactured using a semiconductor process, the requirement of an optical element using a wavelength having low surface precision of a mirror surface cannot be satisfied. However, according to the present invention, precision of a unit micromirror can be controlled such that the micrrormirror can be used in a Blu-ray optical disc system or the like. Third, an Si substrate having a predetermined surface direction is used to manufacture a conventional micromirror. However, according to the present invention, any substrate on which alignment patterns can be formed can be used such that the costs for manufacturing the micromirror can be greatly reduced.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A micromirror array used in controlling a light path of an optical element, the micromirror array comprising:
a substrate;
at least one alignment pattern formed at one surface of the substrate; and
a micromirror seated in the alignment pattern and having at least one mirror surface.

2. The micromirror array of claim 1, wherein the substrate is one of an Si substrate and a glass substrate.

3. The micromirror array of claim 1, wherein the micromirror is formed of at least one of Si, glass, and polymer.

4. The micromirror array of claim 1, wherein one of metal and a dielectric material coated of one of a single layer and multiple layers is used in the mirror surface so as to improve reflectivity.

5. The micromirror array of claim 1, wherein the micromirror comprises a first surface having a first inclined angle and a second surface having a second inclined angle.

6. A method of manufacturing a micromirror array used in controlling a light path of an optical element, the method comprising:
forming at least one alignment pattern in which a micromirror is to be seated on a substrate; and
seating the micromirror having at least one reflective surface in the alignment pattern.

7. The method of claim 6, wherein the forming of the at least one alignment pattern comprises:
coating photoresist on the substrate to form an etching mask layer;
placing a photomask having an opened portion corresponding to the alignment pattern above an upper portion of the etching mask layer and performing a photolithography process and developing the etching mask layer and opening the etching mask layer corresponding to the alignment pattern to form an etching window; and
dry etching the substrate through the etching window to form an alignment pattern in the substrate.

8. The method of claim 6, wherein the forming of at least one alignment pattern further comprises forming an alignment mark to be aligned and bonded to an optical element such as an SiOB on the substrate.

9. The method of claim 8, wherein the forming of the alignment mark comprises:
forming a photoresist layer by coating a photoresist on the substrate;
placing a photomask layer having an opened portion corresponding to the alignment mark above the photoresist layer and performing a photolithography process from an upper portion of the photomask layer;
exposing a portion of the substrate by removing the photoresist layer from the portion in which the alignment mark is to be formed; and
coating an alignment mark material layer on the exposed portion of the substrate and the photoresist layer and removing the photoresist layer to form the alignment mark.

10. The method of claim 6, wherein the seating of the micromirror in the alignment pattern comprises:
placing the micromirror in the alignment pattern;
aligning the micromirror in one-side direction of the alignment pattern; and
injecting a bonder into a contact portion of the micromirror and the alignment pattern.

11. The method of claim 10, wherein the bonder is at least one of a silver paste, UV polymer, a UV bonder, and a photoresist.

12. The method of claim 6, wherein the substrate is one of an Si substrate and a glass substrate.

13. The method of claim 6, wherein the micromirror is formed of at least one of Si, glass, and polymer.

14. The method of claim 6, wherein one of metal and a dielectric material coated of one of a single layer and multiple layers is used in the mirror surface so as to improve reflectivity.

15. The method of claim 6, wherein the micromirror comprises a first surface having a first inclined angle and a second surface having a second inclined angle.
